(19) United States
(12) Patent Application Publication
(10) Pub. No.: US 2015/0095977 A1
(43) Pub. Date: Apr. 2, 2015

(54) METHOD AND DEVICE FOR PROCESSING CHARGING DATA

(71) Applicant: Huawei Technologies Co., Ltd., Shenzhen (CN)

(72) Inventors: Zhongjie GUO, Shenzhen (CN); Guicheng ZHANG, Shenzhen (CN)

(21) Appl. No.: 14/566,131

(22) Filed: Dec. 10, 2014

Related U.S. Application Data
(63) Continuation of application No. PCT/CN2012/077003, filed on Jun. 15, 2012.

(51) Int. Cl. G06F 21/62; G06F 17/30

(52) U.S. Cl. CPC G06F 21/6254; G06F 17/30914
USPC 726/1

(57) ABSTRACT

Disclosed are methods and devices for processing charging data. A method comprises: obtaining charging data; obtaining a data fragment definition of the charging data; segmenting the charging data into a plurality of data fragments according to the data fragment definition; converting the plurality of data fragments into a plurality of corresponding target data fragments according to anonymization conversion rules respectively corresponding to the plurality of data fragments, and configuring a charging rule for each of the target data fragments, wherein the charging rule for each respective target data fragment is the same as the charging rule for the data fragment from which the target data fragment is converted; and assembling the plurality of target data fragments to obtain anonymized target data. The disclosed methods and devices not only enable the anonymization of the charging data, but also enable the target data after anonymization to be used for charging service processing.

### CROSS-REFERENCE TO RELATED APPLICATIONS

This application is a continuation of International Patent Application No. PCT/CN2012/077003, filed on Jun. 15, 2012, which is hereby incorporated by reference in its entirety.

### TECHNICAL FIELD

The present invention relates to information technology field, and in particularly, to a method and a device for processing charging data.

### BACKGROUND

Since systems, such as a convergent billing system (CBS, Convergent Billing System), an online charging system (OCS, Online Charging System), and a customer relationship management (CRM, Customer Relationship Management) system and the like, involve large amounts of personal privacy data, such as personal information like name, identification number, date of birth and so on, as well as a call record or a bill, etc. One of effective methods for protecting personal privacy data is data anonymization by which a part of information in the data is hidden or changed so that the privacy data can not be associated with an actually corresponding person, thereby protecting the personal privacy. Currently, anonymization processing on data is generally completed at an interface. For example, upon printing a bill, the bill generally needs to be printed after being formatted by a format tool. Printing configuration may be applied to the privacy data in a format rule, such as being printed as star or masked by a black block, and thus the privacy data is anonymized in the printing process. Since in this method the anonymization is applied on the data only when interface querying is performed, the risk of leakage of the data is high. If the anonymization of data is carried out in the system in advance, the anonymized data cannot be used for charging service processing since only the charging processing on original data can be achieved currently.

### SUMMARY

Embodiments of the present invention provide a method and a device for processing charging data, which enables the anonymization of charging data, and also enables the anonymized target data to be used for charging service processing.

In one aspect, a method for processing charging data is provided, including: obtaining charging data, and obtaining a data fragment definition of the charging data; segmenting the charging data into a plurality of data fragments according to the data fragment definition; converting the plurality of data fragments into a plurality of corresponding target data fragments according to anonymization conversion rules respectively corresponding to the plurality of data fragments, and configuring a same charging rule as a corresponding data fragment for the target data fragment; assembling the plurality of target data fragments to obtain anonymized target data.

In another aspect, a device for processing charging data is provided, including: an obtaining unit, configured to obtain charging data, and obtaining a data fragment definition of the charging data; a data segmenting unit, configured to segment the charging data into a plurality of data fragments according to the data fragment definition; an anonymization converting unit, configured to convert the plurality of data fragments into a plurality of corresponding target data fragments according to anonymization conversion rules respectively corresponding to the plurality of data fragments, and to configure a same charging rule as a corresponding data fragment for the target data fragment; and a data assembling unit, configured to assemble the plurality of target data fragments to obtain anonymized target data.

In the embodiments of the present invention, a plurality of data fragments of charging data are respectively converted for anonymization, and a same charging rule as a corresponding data fragment is configured for each target data fragment, thereby not only enabling the anonymization of the charging data, but also enabling the target data after anonymization to be used for charging service processing.

### BRIEF DESCRIPTION OF DRAWINGS

In order to illustrate technical solutions of the present invention more clearly, a brief introduction to the accompanying drawings needed in the embodiments of the present invention will be given below. Apparently, the accompanying drawings described below are only some embodiments of the present invention, based on which other drawings can be obtained by those skilled in the art without any inventive efforts.

FIG. 1 is a schematic flow chart of a method for processing charging data according to an embodiment of the present invention;

FIG. 2 is a schematic flow chart of a process of a method for processing charging data according to an embodiment of the present invention;

FIG. 3 is a schematic block diagram of a device for processing charging data according to an embodiment of the present invention.

### DESCRIPTION OF EMBODIMENTS

A clear and complete description of technical solutions of the embodiments of the present invention will be given below, in combination with the accompanying drawings in the embodiments of the present invention. Apparently, the described embodiments are only a part, but not all, of the embodiments of the present invention. All of other embodiments, obtained by those skilled in the art based on the embodiments of the present invention without any inventive efforts, fall into the protection scope of the present invention.

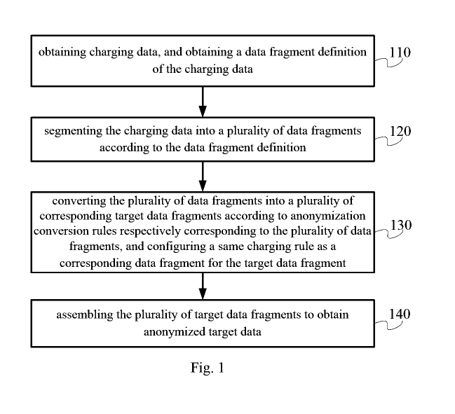

FIG. 1 is a schematic flow chart of a method for processing charging data according to an embodiment of the present invention. The method of FIG. 1 is performed by a device for processing charging data.

110, charging data is obtained and a data fragment definition of the charging data is obtained.

Alternatively, as an embodiment, the device for processing charging data may obtain the data fragment definition of the charging data, according to a corresponding relationship between charging semantic of the charging data and the data fragment definition as well as the charging semantic of the charging data.

The charging semantic is a rule for charging the charging data, and may include a plurality of charging rules. The device for processing charging data may determine the data fragment definition based on the charging semantic of the charging data, on the one hand, to achieve the intended purpose of anonymization, and on the other hand, to be able to remain the original charging semantics. For example, the device may determine the data fragment definition according to division of a charging element in the charging semantic of the charging data. A charging element may be an identification in the charging data, which can be used for charging. For example, a mobile phone number generally includes three parts: a brand identification, a mobile switching center (MSC, Mobile Switching Center) identification and a customer identification, wherein the brand identification and the MSC identification are generally charging elements. When the charging data is a mobile phone number, a data fragment definition may be set that segmenting is performed according to the three parts of the mobile phone number.

Alternatively, as an embodiment, the device for processing charging data may also obtain the data fragment definition, according to a corresponding relationship between the type of charging data and the data fragment definition as well as the type of the charging data.

For example, a type of charging data may be a type of the charging data for charging processing, such as, a mobile phone number, an IMSI (International Mobile Subscriber Identification Number, international mobile subscriber identification number), a switch number, a cell number, a bank card number, or the like. In addition, the type of charging data may also be a home address, gender, name, age, an identification number or a social security number, or the like. This is not limited in the embodiment of the present invention. Charging by a cell number is widely used in foreign countries. Customer telephone fee in a current cell is dynamically adjusted by an independent system according to network traffic of the current cell, and the customer is notified by a message. In addition, in an activity such as a promotion, a holiday sale, etc., an operator may charge by dividing customers based on data such as gender, age, address, identification type, or the like. For example, given the gender “female”, corresponding marketing and gift strategies are provided according to the age in different sections. Similarly, different marketing strategies may also be carried out according to a classification such as income, address or the like. The above charging data is generally deemed as privacy information of a customer, and needs to be anonymized.

Since charging semantic of different types of charging data is different, data fragment definitions are also different. The device for processing charging data may predetermine a corresponding relationship between a charging data type and a data fragment definition, so that a corresponding data fragment definition may be obtained according to the type of the charging data.

120, the charging data is segmented into a plurality of data fragments according to the data fragment definition.

130, the plurality of data fragments are converted into a plurality of corresponding target data fragments according to anonymization conversion rules respectively corresponding to the plurality of data fragments, and a same charging rule as a corresponding data fragment is configured for the target data fragment.

The segmented data fragments may correspond to different charging rules, respectively. Therefore, after converting each data fragment into a corresponding target data fragment according to an anonymization conversion rule, the device for processing charging data may configure a same charging rule as a corresponding data fragment before conversion for the target data fragment.

Alternatively, as another embodiment, the device for processing charging data may obtain the anonymization conversion rules respectively corresponding to the plurality of data fragments, according to a corresponding relationship between data fragment contents and anonymization conversion rules as well as contents of the plurality of data fragments. The corresponding relationship may be predetermined. The corresponding relationship between data fragment contents and anonymization conversion rules is illustrated. For example, when the charging data is a mobile phone number 13701462830, it may be segmented into three data fragments “137”, “0146” and “2830”. There is an anonymization rule as follows: a data fragment with the content of “137” is converted into “166”; in a data fragment first three digits of which are “014”, the first three digit are converted into “111”, and remaining digit(s) of the data fragment does(do) not change; and in a data fragment last two digits of which are “30”, the last two digits are converted into “22”, and remaining digit(s) does(do) not change. Then in this mobile phone number, the date fragment “137” may be converted into “166”, “0146” may be converted into “1116”, and “2830” may be converted into “2822”. The above values are only examples, rather than limit the scope of the embodiments of the present invention.

Alternatively, as another embodiment, the device for processing charging data may obtain the anonymization conversion rules respectively corresponding to the plurality of data fragments, according to a corresponding relationship between data fragment positions and anonymization conversion rules as well as positions of the plurality of data fragments in the charging data. According to the corresponding relationship between

data fragment positions and the anonymization conversion rules, that is, according to a position of a data fragment in the data, an anonymization conversion rule corresponding to the data fragment may be determined. For example, the data is a mobile phone number “13701462830”, and it may be segmented into three data fragments, “137”, “0146” and “2830”. Since the data fragment “137” is located at the first position in the mobile phone number, a corresponding anonymization conversion rule may be retrieved when the data fragment is located at the first position in the second corresponding relationship.

Alternatively, as another embodiment, if an anonymization conversion rule corresponding to at least one data fragment of the plurality of data fragments does not exist, the device for processing charging data may generate the anonymization conversion rule corresponding to the at least one data fragment. That is to say, if there is no anonymization conversion rule corresponding to a data fragment in the corresponding relationship between data fragment contents and anonymization conversion rules or the corresponding relationship between data fragment positions and the anonymization conversion rule, the device may generate the anonymization conversion rule corresponding to the data fragment. In this way, by retrieving the anonymization conversion rule, repetition of the generated anonymization conversion rule can be avoided, and thus charging error incurred by repetition of the anonymization conversion rule can be avoided.

Alternatively, as an another embodiment, the device for processing charging data may generate the anonymization conversion rule corresponding to the at least one data fragment based on charging semantic of the charging data and an anonymization strategy of the data, and the anonymization strategy is predefined based on a charging type of the charging data.

The anonymization strategy may indicate a portion of the charging data which needs to be anonymized. For example, for different types of charging data, different anonymization strategies may be defined. For example, for a mobile phone number, an anonymization strategy may be defined that middle four digits of the mobile phone number are anonymized. For a bank card number, an anonymization strategy may be defined that last eight digits of the bank card number are anonymized. The above values are only examples, rather than limit the scope of the embodiments of the present invention.

Alternatively, as another embodiment, the device for processing charging data may further record the anonymization conversion rule corresponding to the at least one data fragment. That is, the device for processing charging data may record the generated new anonymization conversion rule. For example, the device may record the generated new anonymization conversion rule in the corresponding relationship between data fragment contents and anonymization conversion rules or the corresponding relationship between data fragment positions and anonymization conversion rules.

140, assembling the plurality of target data fragments to obtain the anonymized target data.

For example, in order of the data fragments before conversion corresponding to the plurality of target data fragments, the plurality of target data fragments are assembled to obtain the anonymized target data.

In the embodiments of the present invention, since a charging rule same as a corresponding data fragment is configured for each of the target data fragments, the target data assembled from the target data fragments has same charging semantic as the original charging data. Therefore, not only can the anonymization of the charging data be achieved, but also the target data after anonymization can be used for charging service processing. For example, the target data after anonymization may be used as an anonymized data source for the use of a peripheral system. For example, when a call record is queried, the anonymized target data can be directly used at a call record query interface.

In the prior art, the anonymization of charging data is achieved by performing anonymization setting at an interface, resulting in a high risk of charging data leakage. Furthermore, anonymization settings at respective interfaces are different, which increases the difficulty of maintenance. In the embodiments of the present invention, charging data is segmented according to a data fragment definition of the charging data, and then each data fragment is converted for anonymization according to an anonymization conversion rule corresponding to the each data fragment. The data fragment definition and the anonymization conversion rule, related to a charging type of the charging data, can be predefined at a system layer, without being respectively set at each interface. Therefore, the anonymization can be performed for the charging data at the system layer, and thus the protection effect of the charging data and the performance of the anonymization processing can be improved, and the difficulty of maintenance of the charging data is simplified.

In the embodiments of the present invention, a plurality of data fragments of charging data are respectively converted for anonymization, and a same charging rule as a corresponding data fragment is configured for each target data fragment, thereby not only enabling the anonymization of the charging data, but also enabling the target data after anonymization to be used for charging service processing.

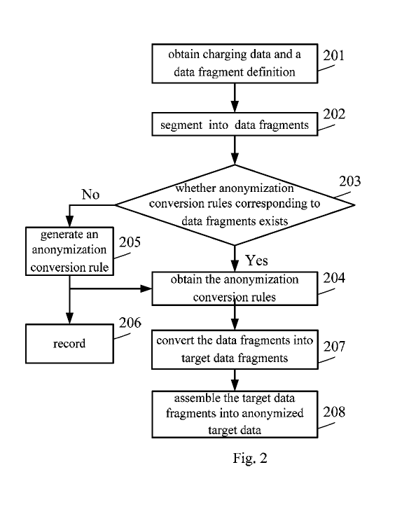

The embodiments of the present invention will be described below in detail in combination with specific examples. FIG. 2 is a schematic flowchart of a process of a method for processing the charging data according to an embodiment of the present invention.

Step 201, a device for processing charging data obtains charging data and a data fragment definition of the charging data.

Alternatively, the device may obtain the data fragment definition of the charging data according to a corresponding relationship between the charging semantic of the charging data and the data fragment definition as well as the charging semantic of the charging data; or may obtain the data fragment definition of the charging data according to a corresponding relationship between the type of the charging data and the data fragment definition and the charging type of the charging data.

Step 202, the device for processing charging data segments the charging data into a plurality of data fragments according to the data fragment definition obtained in step 201.

For example, the charging data may be segmented according to division of charging elements in the charging data. For instance, the charging data is a mobile phone number “13701462830”, and it may be processed as three fragments in a charging system, wherein “137” is a brand identification, “0146” is an MSC identification, and “2830” is a customer identification. The brand identification and the MSC identification may be the charging elements. The charging data “13701462830” may be segmented into three data fragments, “137”, “0146” and “2830”.

Step 203, the device for processing charging data determines whether or not anonymization conversion rules respectively corresponding to the plurality of data fragments exist.

If there is anonymization conversion rules respectively corresponding to the plurality of data fragments in step 202 in a corresponding relationship between data fragment contents and anonymization conversion rules or a corresponding relationship between data fragment positions and anonymization conversion rules, step 204 will be executed, in which the anonymization conversion rules respectively corresponding to the plurality of data fragments are obtained.

If an anonymization conversion rule of a data fragment in step 202 does not exist, step 205 will be executed, in which the device for processing charging data generates the anonymization conversion rule corresponding to the above data fragment according to charging semantic of the charging data and an anonymization strategy of the charging data. The anonymization strategy may be predefined based on the type of the charging data. For example, when the charging data is a mobile phone number, the anonymization strategy may be defined that middle four digits of the mobile phone number are anonymized.

Step 206, the device for processing charging data records the anonymization conversion rule corresponding to the at least one data fragment generated in step 205.

Step 207, the device for processing charging data converts the plurality of data fragments into a plurality of corresponding target data fragments according to the anonymization conversion rules respectively corresponding to the plurality of data fragments, and configures a same charging rule as a corresponding data fragment for the target data fragment.

Step 208, the plurality of target data fragments obtained in step 207 are assembled to obtain anonymized target data.

It should be understood that, the sequence numbers of the above steps are not intended to indicate an execution sequence that should be determined by their functions and inherent logic, and should not make any limitation on the implementation process of the embodiments of the present invention. For example, step 206 may be executed after step 207, and may also be executed after step 208.

The embodiments of the present invention will be described in detail by taking as an example that the charging data is a mobile phone number.

For example, the charging data is a mobile phone number “13899992222”. A device for processing charging data may obtain a data fragment definition of the mobile phone number from a corresponding relationship between a type of charging data and a data fragment definition. For example, the data fragment definition of a mobile phone number may be set that the mobile phone number is segmented according to a brand identification, an MSC identification and a customer identification. The device may segment the mobile phone number into three data fragments “138”, “9999” and “2222” according to the fragment definition of the mobile phone number.

The device may obtain anonymization conversion rules respectively corresponding to the three data fragments from a corresponding relationship between data fragment positions and anonymization conversion rules. For example, an anonymization conversion rule corresponding to the first data fragment “138” is that the data fragment is converted into “166”; an anonymization conversion rule corresponding to the third data fragment “2222” is that first two digits of this data fragment are converted into random numbers, such as 83, and last two digits remain unchanged. In addition, the random numbers may be generated by a random sequence generator.

If there is no anonymization conversion rule corresponding to the second data fragment “9999” in the corresponding relationship between data fragment positions and anonymization conversion rules, the device may generate an anonymization conversion rule corresponding to the second data fragment according to charging semantic of the mobile phone number and an anonymization strategy. For example, the charging semantic of the mobile phone number may be defined that the brand identification and the MSC identification are charging elements, and the anonymization strategy of the mobile phone number may be defined that middle four digits in the mobile phone number are anonymized. Then, the generated anonymization conversion rule corresponding to the second data fragment may be that last two digits in this data fragment are converted into random numbers, such as 85, which may be generated by a random sequence generator, and first two digits in this data fragment remain unchanged.

In addition, the device may record the anonymization conversion rule corresponding to the second data fragment.

According to the anonymization conversion rules corresponding to the above three data fragments, the device may convert the first data fragment “138” into a first target data fragment “166”, convert the second data fragment “9999” into a second target data fragment “9985”, and convert the third data fragment “2222” into a third target data fragment “8322”, and configure a same charging rule as a corresponding data fragment before conversion for each target data fragment.

The device may assemble the above three target data fragments to obtain anonymized target data, i.e. the anonymized mobile phone number “16699858322”.

Since the anonymized mobile phone number “16699858322” has same charging semantic as the original mobile phone number “13899992222”, charging process may be performed on the anonymized mobile phone number “16699858322” according to the charging semantic of the mobile phone number “13899992222”.

In the embodiments of the present invention, a plurality of data fragments of charging data are respectively converted for anonymization, and a same charging rule as a corresponding data fragment is configured for each target data fragment, thereby not only enabling the anonymization of the charging data, but also enabling the target data after anonymization to be used for charging service processing.

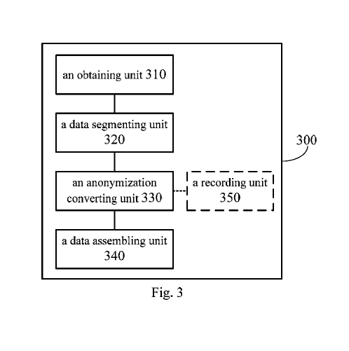

FIG. 3 is a schematic block diagram of a device for processing charging data according to an embodiment of the present invention. The device 300 of FIG. 3 includes an obtaining unit 310, a data segmenting unit 320, an anonymization converting unit 330 and a data assembling unit 340.

The obtaining unit 310 obtains charging data, and obtains a data fragment definition of the charging data. The data segmenting unit 320 segments the charging data into a plurality of data fragments according to the data fragment definition. The anonymization converting unit 330 converts the plurality of data fragments into a plurality of corresponding target data fragments according to anonymization conversion rules respectively corresponding to the plurality of data fragments, and configures a same charging rule as a corresponding data fragment for the target data fragment. The data assembling unit 340 assembles the plurality of target data fragments to obtain anonymized target data.

In the embodiments of the present invention, a plurality of data fragments of charging data are respectively converted for anonymization, and a same charging rule as a corresponding data fragment is configured for each target data fragment, thereby not only enabling the anonymization of the charging data, but also enabling the anonymized target data to be used for charging service processing.

The processes of the embodiments of the methods in FIG. 1 and FIG. 2 may be referred to for other operations and functions of the device 300 which will not be described redundantly to avoid repetition.

Alternatively, as an embodiment, the obtaining unit 310 may obtain the data fragment definition according to a corresponding relationship between charging semantic of the charging data and the data fragment definition as well as the charging semantic of the charging data. Or, the obtaining unit 310 may obtain the data fragment definition according to a corresponding relationship between the type of the charging data and the data fragment definition as well as the type of the charging data.

Alternatively, as another embodiment, the anonymization converting unit 330 may obtain the anonymization conversion rules respectively corresponding to the plurality of data fragments according to a corresponding relationship between data fragment contents and anonymization conversion rules as well as contents of the plurality of the data fragments. Or, the anonymization converting unit 330 may obtain the anonymization conversion rules respectively corresponding to the plurality of data fragments according to a corresponding relationship between data fragment positions and anonymization conversion rules as well as positions of the plurality of the data fragments in the charging data.

Alternatively, as another embodiment of the present invention, if an anonymization conversion rule corresponding to at least one data fragment of the plurality of data fragments does not exist, the anonymization converting unit 330 may generate the anonymization conversion rule corresponding to the at least one data fragment.

Alternatively, as another embodiment, the anonymization converting unit 330 generates the anonymization conversion rule corresponding to the at least one data fragment based on charging semantic of the charging data and an anonymization strategy of the charging data, and the anonymization strategy is predefined based on the type of the charging data.

Alternatively, as another embodiment, as shown in FIG. 3, the device 300 may further include a recording unit 350. The recording unit 350 may record the anonymization conversion rule corresponding to the at least one data fragment.

In the embodiments of the present invention, a plurality of data fragments of charging date are respectively converted for anonymization, and a same charging rule as a corresponding data fragment is configured for each target data fragment, thereby not only enabling the anonymization of the charging, but also enabling the anonymized target data to be used for charging service processing.

It may be clearly understood for those skilled in the art that, for convenience and simplicity of description, corresponding processes of the aforementioned method embodiments may be referred to for specific operation processes of the above described systems, devices and units, which are not described redundantly herein.

In the several embodiments provided by the present application, it should be understood that disclosed systems, devices and methods may be implemented in other manners For example, device embodiments described above are just illustrative. For example, the units may be divided according to logical functions, and there may be other division manners for practical implementations. For example, multiple units or components may be combined or integrated into another system, or some features may be neglected or may not be performed. In addition, the shown or discussed mutual coupling or direct coupling or communication link may be an indirect coupling or communication link for devices or units through some interfaces, which may be in an electrical form, a mechanical form or other form.

The units described as separated parts may be or may not be physically separated, and the parts displayed as units may be or may not be physical units, which may be located in one place or distributed to multiple network elements. Part or all units therein may be selected to implement the objective of solutions provided in the present invention according to an actual demand.

In addition, in various embodiments of the present invention, various functional units may be integrated into one processing unit, or the respective units may exist separately and physically, or two or more units may be integrated into one unit.

If the function is implemented in the form of a software functional unit and is sold or used as an independent product, the function may be stored in a computer readable storage medium. Based on this understanding, part of the technical solution, or the parts that that makes contributions to the prior art of the technical solution in the present invention may be essentially embodied in the form of a software product. The computer software product may be stored in a storage medium, and includes a number of instructions that enable a piece of computer equipment (may be a personal computer, a server, or a network equipment) to execute all or part of steps of the methods described in various embodiments of the present invention. The preceding storage mediums includes various mediums that can store codes, such as, a U disk, a removable hard disk, a read-only memory (ROM, Read-Only Memory), a random access memory (RAM, Random Access Memory), a magnetic disk, an optical disk, or the like.

The above descriptions are only some embodiments of the present invention, rather than limiting the protection scope of the present invention. It is easy for any one skilled in the art to conceive changes or substitutions within the scope disclosed by the present invention, and the changes and substitutions should fall in the protection scope of the present invention. Therefore, the protection scope of the present invention should be defined by the claims.

1. A method for processing charging data, comprising:
obtaining charging data;
obtaining a data fragment definition of the charging data;
segmenting the charging data into a plurality of data fragments according to the data fragment definition;
converting the plurality of data fragments into a plurality of corresponding target data fragments according to anonymization conversion rules respectively corresponding to the plurality of data fragments;
configuring a charging rule for each of the plurality of target data fragments, wherein the charging rule for each respective target data fragment is the same as the charging rule for the data fragment from which the target data fragment is converted; and
assembling the plurality of target data fragments to obtain anonymized target data.

2. The method according to claim 1, wherein the obtaining the data fragment definition of the charging data comprises:
obtaining the data fragment definition, according to a corresponding relationship between charging semantics of the charging data and the data fragment definition as well as the charging semantics of the charging data.

3. The method according to claim 1, wherein the obtaining the data fragment definition of the charging data comprises:
obtaining the data fragment definition, according to a corresponding relationship between a type of the charging data and the data fragment definition as well as the type of the charging data.

4. The method according to claim 1, wherein the converting the plurality of data fragments into a plurality of corresponding target data fragments according to anonymization conversion rules respectively corresponding to the plurality of data fragments comprises:
obtaining the anonymization conversion rules respectively corresponding to the plurality of data fragments, according to a corresponding relationship between data fragment contents and anonymization conversion rules as well as contents of the plurality of data fragments.

5. The method according to claim 1, wherein the converting the plurality of data fragments into a plurality of corresponding target data fragments according to anonymization conversion rules respectively corresponding to the plurality of data fragments comprises:
obtaining the anonymization conversion rules respectively corresponding to the plurality of data fragments, according to a corresponding relationship between data fragment positions and anonymization conversion rules as well as positions of the plurality of data fragments in the charging data.

6. The method according to claim 2, wherein the converting the plurality of data fragments into a plurality of corresponding target data fragments according to anonymization conversion rules respectively corresponding to the plurality of data fragments comprises:
obtaining the anonymization conversion rules respectively corresponding to the plurality of data fragments, according to a corresponding relationship between data fragment contents and anonymization conversion rules as well as contents of the plurality of data fragments.

7. The method according to claim 2, wherein the converting the plurality of data fragments into a plurality of corresponding target data fragments according to anonymization conversion rules respectively corresponding to the plurality of data fragments comprises:
obtaining the anonymization conversion rules respectively corresponding to the plurality of data fragments, according to a corresponding relationship between data fragment positions and anonymization conversion rules as well as positions of the plurality of data fragments in the charging data.

8. The method according to claim 1, wherein before the converting the plurality of data fragments into a plurality of corresponding target data fragments according to anonymization conversion rules respectively corresponding to the plurality of data fragments, the method comprising:
determining that an anonymization conversion rule corresponding to at least one data fragment of the plurality of data fragments does not exist, and
generating the anonymization conversion rule corresponding to the at least one data fragment.

9. The method according to claim 8, wherein the generating the anonymization conversion rule corresponding to the at least one data fragment comprises:
generating the anonymization conversion rule corresponding to the at least one data fragment based on charging semantics of the charging data and an anonymization strategy of the charging data, wherein the anonymization strategy is predefined based on a type of the charging data.

10. The method according to claim 8, further comprising:
recording the anonymization conversion rule corresponding to the at least one data fragment.

11. A device for processing charging data, comprising:
an obtaining unit, configured to obtain charging data, and obtain a data fragment definition of the charging data;
a data segmenting unit, configured to segment the charging data into a plurality of data fragments according to the data fragment definition;
an anonymization converting unit, configured to convert the plurality of data fragments into a plurality of corresponding target data fragments according to anonymization conversion rules respectively corresponding to the plurality of data fragments, and to configure a charging rule for each of the target data fragments, wherein the charging rule for each respective target data fragment is the same as the charging rule for the data fragment from which the target data fragment is converted; and
a data assembling unit, configured to assemble the plurality of target data fragments to obtain anonymized target data.

12. The device according to claim 11, wherein the obtaining unit is configured to:
obtain the data fragment definition according to a corresponding relationship between charging semantics of the charging data and the data fragment definition as well as the charging semantic of the charging data.

13. The device according to claim 11, wherein the obtaining unit is configured to:
obtain the data fragment definition according to a corresponding relationship between the type of the charging data and the data fragment definition as well as the type of the charging data.

14. The device according to claim 11, wherein the anonymization converting unit is configured to obtain the anonymization conversion rules respectively corresponding to the plurality of data fragments according to a corresponding relationship between data fragment contents and anonymization conversion rules as well as the contents of the plurality of data fragments.

15. The device according to claim 11, wherein the anonymization converting unit is configured to obtain the anonymization conversion rules respectively corresponding to the plurality of data fragments according to a corresponding relationship between data fragment positions and anonymization conversion rules as well as positions of the plurality of data fragments in the charging data.

16. The device according to claim 12, wherein the anonymization converting unit is configured to obtain the anonymization conversion rules respectively corresponding to the plurality of data fragments according to a corresponding relationship between data fragment contents and anonymization conversion rules as well as the contents of the plurality of data fragments.

17. The device according to claim 12, wherein the anonymization converting unit is configured to obtain the anonymization conversion rules respectively corresponding to the plurality of data fragments according to a corresponding relationship between data fragment positions and anonymization conversion rules as well as positions of the plurality of data fragments in the charging data.

18. The device according to claim 11, wherein the anonymization converting unit is further configured to generate an anonymization conversion rule corresponding to at least one data fragment in response to determining that the anonymization conversion rule corresponding to the at least one data fragment of the plurality of data fragments does not exist.

19. The device according to claim 18, wherein the anonymization converting unit is configured to generate the anonymization conversion rule corresponding to the at least one data fragment based on charging semantic of the charging data and an anonymization strategy of the charging data, wherein the anonymization strategy is predefined based on a type of the charging data.

20. The device according to claim 18, wherein the device further comprises:
a recording unit, configured to record the anonymization conversion rule corresponding to the at least one data fragment.
